(19) United States
(12) Patent Application Publication
(10) Pub. No.: US 2009/0110051 A1
(43) Pub. Date: Apr. 30, 2009

(54) METHOD AND SYSTEM FOR REDUCING THE IMPACT OF LATENCY ON VIDEO PROCESSING

(76) Inventors: Steven B. Lindsay, Bend, OR (US); Narendra Sankar, Campbell, CA (US); Chad Kendall, Burnaby (CN)

Correspondence Address: MCANDREWS HELD & MALLOY, LTD, 500 WEST MADISON STREET, SUITE 3400, CHICAGO, IL, 60661, US

(21) Appl. No.: 11/927,050

(22) Filed: Oct. 29, 2007

(51) Int. Cl. H04B 1/66

(52) U.S. Cl. 375/240.01

(57) ABSTRACT

The disclosed systems and methods relate to reducing the effect of video processing latency in devices that utilize PCI Express Active State Power Management (PCI-E ASPM). Power state transition delay may be reduced by initiating an early L1 exit based on a video processing stimulus. Aspects of the present invention may enable a higher level of performance and responsiveness while supporting the benefits of ASPM. Aspects of the present invention may be embodied in a video processing device that uses a video accelerator with a PCI-E interface.

### RELATED APPLICATIONS

This application is related to U.S. patent application, METHOD AND SYSTEM FOR IMPROVING PCI-E L1 ASPM EXIT LATENCY, Attorney Docket No. 18822US01, filed Oct. 11, 2007 by Steven B. Lindsay, which is hereby incorporated herein by reference in its entirety for all purposes.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The Peripheral Component Interconnect Express (PCI-E) interface may be found in servers, desktops, and mobile PCs. An important power saving feature of PCI-E is Active State Power Management (ASPM). When L1 ASPM is enabled on a given PCI-E link, and the link has been inactive for a period of time (e.g. tens or hundreds of microseconds), the PCI-E link will transition to a L1 state that consumes much less power than the full power, fully functional L0 (on) state. While in the L1 state, the PCI-E clock may be stopped and a PLL may be powered down to save power. However, in order for a given device to start a DMA and transfer data across the PCI-E link, the link must be returned to the L0 state.

The process of transitioning from L1 to L0 is not instantaneous. This period of time is called the “L1 exit latency”. The L1 exit latency starts from the point in time a device determines that it needs to make a PCI-E transaction (e.g. a DMA) and initiates the transition to L0. The L1 exit latency ends when the PCI-E link has been fully transitioned to a L0 state. The precise L1 exit latency will depend on the design of the devices at both ends of the PCI-E link, but this may be greater than 20 microseconds if the PLL was not powered down and may be greater than 100 microseconds if the PLL was powered down.

It is desirable for video processors that use a PCI-E interface to support L1 ASPM in order to save power during periods of inactivity on the interface. However, the long L1 latencies may negatively affect responsiveness and performance. For example, the L1 exit latency may increase video latency or degrade video performance.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for improving video processing latency by initiating a power-state transition at an earlier point in time, as shown in and/or described in connection with at least one of the figures, as set forth more completely in the claims. Advantages, aspects and novel features of the present invention, as well as details of an illustrated embodiment thereof, will be more fully understood from the following description and drawings.

### BRIEF DESCRIPTION OF THE DRAWINGS

FIG. 1 is a flowchart illustrating a first exemplary method for improving video processing latency in accordance with a representative embodiment of the present invention;

FIG. 2 is an illustration of an exemplary system for improving video processing latency in accordance with a representative embodiment of the present invention;

FIG. 3A is an illustration of an exemplary video processor for decoding in accordance with a representative embodiment of the present invention;

FIG. 3B is an illustration of an exemplary video processor for encoding in accordance with a representative embodiment of the present invention; and

FIG. 3C is an illustration of an exemplary video processor for transcoding in accordance with a representative embodiment of the present invention.

### DETAILED DESCRIPTION OF THE INVENTION

Aspects of the present invention may be embodied in a video processing device with a PCI-E interface that supports ASPM. Aspects of the present invention relate to reducing the impact of the PCI Express (PCI-E) L1 Active State Power Management (ASPM) exit latency by initiating early L1 exit based on a video processing stimulus. The improved latency may enable a higher level of performance and responsiveness while supporting the benefits of ASPM. For example, video throughput performance may be improved, and the response time between playback initiation and decoded frame availability may be reduced. The improved latency may also enable a low power mode when video processing is offloaded from a CPU to a hardware accelerator. By reducing the power consumed during CPU idle periods, battery life of portable devices may be increased. Although the following description may refer to a particular embodiment of a PCI-E interface, many other embodiments may also use these systems and methods. Aspects of the present invention may reduce latency in other processes that utilize a PCI-E interface.

The video processing device with an accelerator and PCI-E interface may anticipate the need to exit the L1 state early and may, therefore, initiate a reduced-latency transition from the L1 state to the L0 PCI-E state. If the video processing device is unable to reduce L1 exit latency, the performance and responsiveness of a video application may be degraded. Therefore, ASPM with L1 exit latency may be incompatible with quality video processing.

In accordance with various embodiments of the present invention a video processing device may anticipate, based on a video processing stimulus, the need to exit the L1 state much earlier than normal—well before a DMA would have to be initiated. In other words, aspects of the present invention enable a video processing device to initiate the L1 to L0 transition well before the device has a pending PCI-E transaction (e.g. a DMA read or write) that is ready to be initiated. In accordance with aspects of the present invention, the video processing device may initiate a transition from the low power, L1 state, to the full power, L0 state. By anticipating and initiating the transition earlier, some of the L1 exit latency may be masked, and the PCI-E link may return to an L0 state faster than it otherwise would. Returning to the L0 state faster may improve performance and responsiveness of the video processing device that supports PCI-E Active State Power Management.

The L1 to L0 transition may be initiated by a device once it is requested to initiate a PCI-E transaction. To reduce the impact of the latency, the L1 to L0 transition may be initiated, before the device actually has a pending PCI-E transaction. The L1 to L0 transition may begin when the video device is able to make a determination that it will need to make a DMA request in the near future. This may provide a head start that is sufficient to completely hide the L1 exit latency. For example, if the head start is on the order of 20-100 microseconds before the DMA request needs to be initiated, the L1 exit latency will have no impact on performance or application latency.

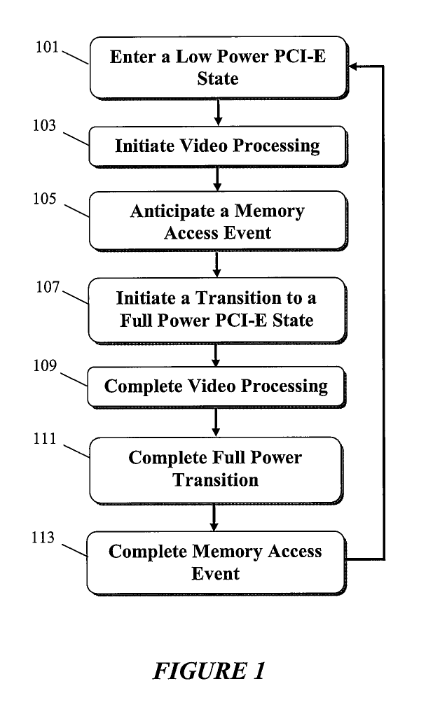

FIG. 1 is a flowchart illustrating a first exemplary method for improving video processing latency in accordance with a representative embodiment of the present invention. At 101, the video processing device enters a low power state, L1. Video processing may be initiated at 103. At 105, it may be determined that a memory access event (e.g. DMA read or write) is required.

If the PCI-E interface is in the L1 state, the video processor may initiate the L1 to L0 transition at 107. Initiating the transition may occur before the video processing is complete, 109. Once the transition to L0 is complete at 109, the memory access event may be executed at 111.

By requesting an “early” L1 to L0 transition, the video processing device may transition the bus to an L0 state without actually having to make a DMA request. The PCI-E specification allows a transition to L0 even if the transition does not immediately result in a PCI-E transaction. The penalty of making an unnecessary transition from L1 to L0 is that the bus will consume slightly more power for a small period of time.

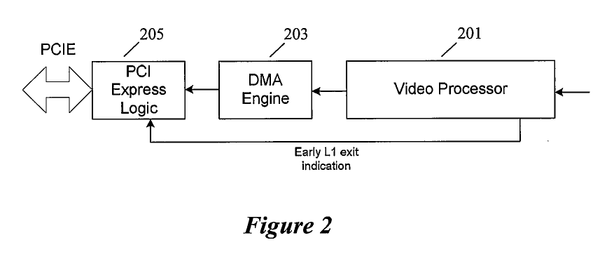

FIG. 2 an illustration of an exemplary system for improving video processing latency in accordance with a representative embodiment of the present invention.

To support an early L1 to L0 transition a signal from a video processor, 201, to PCI-E logic core, 205, instructs the PCI-E core to initiate a L1 to L0 transition. This signal may be edge triggered, and the video processor, 201, may generate a pulse when it wants to “hint” to the PCI-E core to go to L0. For debug and diagnostic purposes, the software may enable or disable the use of this signal. This may be accomplished via device specific register bits that could be configured by the device driver.

The PCI-E logic core, 205, may contain logic to recognize a pulse on this signal. If the feature is enabled at the device level and the device is in a L1 ASPM state and a D0 device state, the PCI-E core, 205, may initiate a L1 to L0 transition when it recognizes the signal asserted (i.e. when it detects a rising edge on this signal). Once the transition had been made to L0, the PCI-E core, 205, may reset the PCI-E inactivity timer, so that if there is no activity on the bus for a certain amount of time, the device would initiate a transition back to L1. This signal should be completely ignored by the PCI-E core if the device is in a D3 state. If the device was not in the L1 ASPM state, and was rather in the L0 state, the device may immediately reset its PCI-E inactivity timer when it detected the pulse on this signal. This would provide the benefit of eliminating a possible unnecessary L0 to L1 to L0 transition if the inactivity timer was close to expiring when the early indication signal was asserted.

To support an early L1 to L0 transition due to video processing activity, the video processor, 201, may include logic that allows the video processor, 201, to generate a pulse on the signal to the PCI-E core, 205. The pulse may trigger the PCI-E core, 205, to start the L1 to L0 transition concurrently with (or shortly after) the initiation of the video processing activity.

As an alternative to using the pulse, a level signal may be used. The level signal would be set when the video processor knows it needs to exit L1 at some point in the future and would be cleared when the DMA request is made. The video processor, 201, may also assert another level signal which resets the inactivity timer, thereby taking the link out of L1 if the PCI-E core, 205, is in the L1 state and preventing a transition to the L1 state if in the PCI-E core, 205, is in the L0 state.

An “early L1 exit delay” register may be added, which could be configured by software to delay the pulse (or level signal) that goes from the video processor, 201, to the PCI-E core, 205, by n microseconds. The delay value may be chosen such that the early L1 exit pulse would be generated before the DMA engine, 203, would otherwise issue an exit pulse and thus reduce the impact of L1 exit latency. With the delay, software can tune the actual L1 exit time to precisely the amount of time needed to hide the exit latency, without exiting too early such that more power is consumed.

When processing live video input, a frame arrival indication may be used by the video processor to initiate an L1 exit. For digital video inputs, the first data received may be used as the early L1 exit indication. For analog inputs, the vertical sync input could be used as the early L1 exit indication.

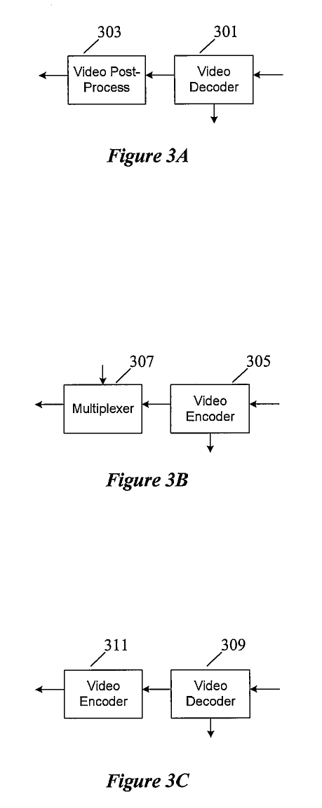

FIG. 3A is an illustration of an exemplary video processor, 201, for decoding in accordance with a representative embodiment of the present invention. The video processor, 201, may comprise a video decoder, 301, and a post-processor, 303. The video decoder, 301, is a device that takes compressed data in one of a number of formats (e.g. H.264, MPEG2, VC-1, AVS, DIVX, etc . . . ) and outputs uncompressed video frames. The post-processor, 303, operates on the uncompressed video frames and may perform scaling, de-interlacing, and/or chroma conversion. For the video decoder, 301, uncompressed frames may be pushed back to the PC memory at a fixed frame rate with a delay between frames. During this delay, the PCI-E link may enter L1 to save power. However, the long latency necessary to return to L0 (e.g. up to 150 microseconds) may create a delay for the frame to reach the PC memory, thereby increasing latency and causing the video decoder, 301, to back up.

When the video decoder, 301, backs up, frames may be lost, resulting in the need to disable L1 and suffer the power consequences of doing so. The video decoder, 301, may generate an early indication that a video frame is about to be ready to be pushed back to PC memory. This early indication may trigger an earlier L1 to L0 transition.

Due to post-processing, 303, a frame may be decoded tens of microseconds before it is available to be pushed back to the PC memory. The time of availability (prior to post-processing) may be used to initiate the L1 exit, thus cutting the latency considerably. To reduce the latency even further, it may be possible to initiate the L1 exit when a decode operation is started.

FIG. 3B is an illustration of an exemplary video processor, 201, for encoding in accordance with a representative embodiment of the present invention. The video processor, 201, may comprise a video encoder, 305, and a multiplexer, 307. The video encoder, 305, is a device that takes uncompressed video frames and outputs data in a standard compressed video format (e.g. H.264, MPEG2, VC-1, AVS, DIVX, etc . . . ). Video data may be compressed in a video encoder, 305. The encoded video data may then be combined with audio data in the multiplexer, 307.

Since encoded video data may be available prior to the multiplexing with audio data, an early L1 exit indication may be generated according the video encoder, 305. This early L1 exit indication would therefore occur before the combined audio and video data is transmitted back to PC memory.

By initiating the early L1 to L0 transition when the compressed video data is available instead of after the data is multiplexed, latency may be reduced, thereby improving overall encode performance.

The video processor may also transcode digital video input by converting compressed video data that conforms with a first standard (e.g. H.264, MPEG2, VC-1, AVS, DIVX, etc . . . ) into compressed video data that conforms with a second standard. This transcoding may be performed directly, for example by using a rate transformation. Alternatively, transcoding may be performed by decoding according to the first standard and re-encoding according to the second standard.

FIG. 3C is an illustration of an exemplary video processor, 201, for encoding in accordance with a representative embodiment of the present invention. Video data may be decompressed in a video decoder, 309. The decompressed video data may then be re-encoded in a video encoder, 311.

Since decompressed video data may be available prior to the re-encoding, an early L1 exit indication may be generated in the video decoder, 309. This early L1 exit indication would therefore occur before the transcoded video data is written in PC memory.

By initiating the early L1 to L0 transition when the decompressed video data is available instead of after the data is transcoded, latency may be reduced, thereby improving overall encode performance.

The present invention may be realized in hardware, software, or a combination of hardware and software. The present invention may be realized in a centralized fashion in an integrated circuit or in a distributed fashion where different elements are spread across several circuits. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for reducing the impact of latency on video processing, wherein the method comprises:
entering a low power PCI-E state;
determining a memory access time according to a video processing event; and
transitioning to a full power PCI-E state based on the memory access time.

2. The method in claim 1, wherein the video processing event is encoding a video frame.

3. The method in claim 2, wherein the encoded video frame is multiplexed with an audio frame.

4. The method in claim 1, wherein the video processing event is decoding a video frame.

5. The method in claim 4, wherein the decoded video frame is post-processed.

6. The method in claim 1, wherein transitioning to the full power state occurs after a delay.

7. The method in claim 6, wherein the delay is based on time.

8. The method in claim 1, wherein the video processing event is receiving a video signal.

9. The method in claim 8, wherein the video signal is an analog video signal.

10. The method in claim 9, wherein an early low power exit indication is generated according to a vertical sync input.

11. The method in claim 8, wherein the video signal is a digital video signal.

12. The method in claim 11, wherein an early low power exit indication is generated according to a first arrival of data.

13. A system for reducing the impact of latency during video processing, wherein the system comprises:
an interface having a power management feature, wherein the power management feature comprises a low power PCI-E state and a full power PCI-E state; and
a video processor for instructing the interface to initiate a transition from the low power PCI-E state to the full power PCI-E state, wherein the video processor determines a requirement for the full power PCI-E state.

14. The system in claim 13, wherein the video processor comprises an encoder.

15. The system in claim 13, wherein the controller comprises a decoder.

16. The system in claim 13, wherein the controller generates a delay between the determination of the full power PCI-E state requirement and the initiation of the transition.

17. The system in claim 16, wherein the delay is based on time.

18. A video processor, wherein the video processor comprises:
a video encoder for compressing video data and instructing a PCI-E interface to initiate a transition from a low power state to a full power state; and
a multiplexer for merging the compressed video data with a digital audio signal.

19. The video processor of claim 18, wherein the transition of the PCI-E interface is initiated before the compressed video data is merged with the digital audio signal.

20. A video processor, wherein the video processor comprises:
a video decoder for decompressing video data and instructing a PCI-E interface to initiate a transition from a low power state to a full power state; and
a post-processor for formatting the decompressing video data.

21. The video processor of claim 20, wherein the transition of the PCI-E interface is initiated before the decompressed video data is formatted.

22. A video processor, wherein the video processor comprises:
a video transcoder for changing the compression scheme of encoded video data from a first standard to a second standard and instructing a PCI-E interface to initiate a transition from a low power state to a full power state.

23. The video processor of claim 22, wherein the transcoder initiates the PCI-E interface transition after the encoded video data is decompressed according to the first standard.
